(19) United States
(12) Patent Application Publication
(10) Pub. No.: US 2014/0064169 A1
(43) Pub. Date: Mar. 6, 2014

(54) DUTY CYCLED TRANSMISSIONS

(71) Applicant: QUALCOMM INCORPORATED, San Diego, CA (US)

(72) Inventors: Maarten Menzo Wentink, Naarden (NL); Didier Johannes Richard Van Nee, De Meern (NL)

(73) Assignee: QUALCOMM Incorporated, San Diego, CA (US)

(21) Appl. No.: 13/786,645

(22) Filed: Mar. 6, 2013

Related U.S. Application Data
(60) Provisional application No. 61/697,061, filed on Sep. 5, 2012.

(51) Int. Cl. H04W 52/02

(52) U.S. Cl. CPC H04W 52/0261
USPC 370/311

(57) ABSTRACT

Systems, methods, and devices for saving power in wireless communications devices are described herein. In some aspects, an apparatus for wireless communication includes a memory unit configured to store transmission power information, and a processor operationally coupled to the memory unit, the processor configured to retrieve the transmission power information from the memory unit and further configured to define, based at least partially on the transmission power information, a duration of the data segment and a duration of an idle time segment such that an average transmit power by a transmitter over the duration of the data segment and the duration of the idle time segment is below a threshold power value.

### CROSS REFERENCE TO RELATED APPLICATIONS

This application claims benefit under 35 U.S.C. §119(e) to U.S. Provisional Patent Application No. 61/697,061, entitled “DUTY CYCLED TRANSMISSIONS,” and filed on Sep. 5, 2012, the disclosure of which is hereby incorporated by reference in its entirety.

### FIELD

This technology relates generally to wireless communications, and more specifically to systems, methods, and devices for controlling duty cycle transmissions.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks may differ according to the switching/routing technique used to interconnect the various network nodes and devices (e.g., circuit switching vs. packet switching), the type of physical media employed for communication (e.g., wired vs. wireless), and the communication protocols used.

Wireless networks are often preferred when the network elements are mobile and thus have dynamic connectivity needs, or if the network architecture is formed in an ad hoc, rather than fixed, topology. Wireless networks employ physical media in an unguided propagation mode using electromagnetic waves in the radio, microwave, infra-red, and/or optical frequency bands. Wireless networks may advantageously facilitate user mobility and rapid field deployment when compared to some fixed wired networks.

In some areas, the average transmission power for a wireless device may be required by regulations to be below a certain limit, although peak power transmissions may be higher than the average regulatory limit. Accordingly, it can be desirable to control the transmitted power of a wireless device such that a higher peak transmission power is available while still complying with average transmission power regulations for the wireless device.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages for communications in a wireless network.

One aspect of this disclosure provides a wireless communications apparatus. The apparatus for wireless communication includes a memory unit configured to store transmission power information. The apparatus further includes a processor operationally coupled to the memory unit. The processor is configured to retrieve the transmission power information from the memory unit and is further configured to define, based at least partially on the transmission power information, a duration of the data segment and a duration of an idle time segment such that an average transmit power, by a transmitter over the duration of the data segment and the duration of the idle time segment, is below a threshold power value.

Another aspect of this disclosure provides a method of transmitting data from one wireless device to another wireless device. The method includes storing transmission power information in a memory unit. The method further includes retrieving the transmission power information from the memory unit and defining, based at least partially on the transmission power information, a duration of a data segment and a duration of an idle time segment such that an average transmit power by a transmitter over the duration for transmitting the data segment and the duration of the idle time segment is below a threshold power value.

Another aspect of this disclosure provides an apparatus for transmitting data between at least two wireless devices. The apparatus includes means for storing transmission power information in a memory unit. The apparatus further includes means for retrieving the transmission power information from the memory unit and defining, based at least partially on the transmission power information, a duration of a data segment and a duration of an idle time segment such that an average transmit power by a transmitter over the duration for transmitting the data segment and the duration of the idle time segment is below a threshold power value.

Yet another aspect of this disclosure provides a non-transitory computer-readable medium (or storage) that stores set of executable program instructions that direct an apparatus including a processor to perform a process that includes storing transmission power information in a memory unit, retrieving the transmission power information from the memory unit, and defining, based at least partially on the transmission power information, a duration of a data segment and a duration of an idle time segment such that an average transmit power by a transmitter over the duration for transmitting the data segment and the duration of the idle time segment is below a threshold power value.

Another aspect of the disclosure includes a communication system, having at least two communication devices. Each device includes a memory unit configured to store transmission power information, and a processor operationally coupled to the memory unit, the processor configured to retrieve the transmission power information from the memory unit and further configured to define, based on the transmission power transmission power information, a duration of a data segment and a duration of an idle time segment such that an average transmit power by a transmitter over the duration of the data segment and the duration of the idle time segment is below a threshold power value. The processor is further configured to generate packets that include at least one data segment and idle time segment. Each device further includes a transceiver configured to communicate the data packets with another of the at least two communication devices. Each of the at least two communication devices may be configured not to transmit while during an idle time segment of a packet it is communicating, and not to transmit during an idle time segment of a packet that another of the at least two communication devices is communicating.

Another innovative implementation includes a method of communicating data between at least two devices, the method including defining a duration of at least one data segment and the duration of at least one idle time segment such that an average transmit power output over the time of transmitting the at least one data segment and the at least one idle time segment is below a threshold value. The method also includes transmitting a packet that includes the at least one data segment and the at least one idle time segment, where none of the at least two devices transmitting during the at least one idle time segment.

### BRIEF DESCRIPTION OF THE DRAWINGS

FIG. 1 illustrates a schematic of an example of a wireless communication system in which aspects of the present disclosure may be employed.

FIG. 2 illustrates a functional block diagram of an example of a wireless device that may be employed within the wireless communication system of FIG. 1.

FIG. 3 illustrates a schematic of an example of a data segment and an idle time segment that may form part of a packet.

FIG. 4 illustrates a schematic of an example of a packet that includes a header, a data segment and an idle time segment.

FIG. 5 illustrates a schematic of an example implementation of a packet where the transmission of data is fragmented.

FIG. 6 illustrates a schematic of an example of a packet having a fixed length and including a data segment and an idle time segment.

FIG. 7 illustrates a schematic of an example of a packet having a fixed length having multiple data segments and idle time segments.

FIG. 8 illustrates a schematic of two examples of two duty cycled transmissions of multiple duty cycled frames.

FIG. 9 illustrates a schematic of an example of a duty cycled transmission with coexistence support.

FIG. 10 illustrates a block diagram of an example of a device for defining the duration of at least one data segment and at least one idle time segment.

FIG. 11 is a flowchart illustrating a process for wirelessly communicating such that the average transmission power is less than a threshold.

FIG. 12 is a flowchart illustrating another process for wirelessly communicating such that the average transmission power is less than a threshold.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure. Based on the teachings herein, a person of ordinary skill in the art should appreciate that the scope of the disclosure is intended to cover any aspect of the novel systems, apparatuses, and methods disclosed herein, whether implemented independently of, or combined with, any other aspect of the invention. For example, an apparatus may be implemented, or a method may be practiced, using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of certain aspects and features. The detailed description and drawings are illustrative of the disclosure, rather than limiting.

For ease of reference, certain acronyms that are used herein are listed below:

AP Access Point

AID Association Identifier

BS Base Station

BSS Basic Service Set

BSSID Basic Service Set Identifier

BTS Base Transceiver Station

CCA Clear Channel Assessment

DL Downlink

DSSS Direct-Sequence Spread Spectrum

GID Group Identifier

OFDM Orthogonal Frequency Division Multiplexing

OFDMA Orthogonal Frequency Division Multiplexing Access

MAC Media Access Control

MAN Metropolitan Area Network

MPDU MAC Protocol Data Unit

PAID Partial Association Identifier

PAN Personal Area Network

pBSSID Partial Basic Service Set Identifier

PDA Personal Digital Assistant

PDSU PHY Service Data Unit

PHY Physical Layer

PPDU PHY Protocol Data Unit

SIP Session initiation Protocol

STA Station

TF Transceiver Function

UE User Equipment

WLAN Wireless Local Area Network

WLL Wireless Local Loop

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be (one or more of) two types of devices: an access point (“AP”) and a client, also referred to as a station (“STA”). An AP may be a hub or base station for the WLAN and a STA may be a user of the WLAN. For example, a STA may be a laptop computer, a personal digital assistant (PDA), a mobile phone, etc. User equipment (UE) may refer to any wireless communication device operated by a user, for example, a laptop computer, a personal digital assistant (PDA), a mobile phone, and may also be referred to as a STA. Wi-Fi is a broad term that may refer to wireless local area network (WLAN) products or technology that are based on IEEE 802.11 protocol such as 802.11ah. For wireless communication, a STA may connect to an AP via a Wi-Fi compliant wireless link to obtain general connectivity to the Internet or to other wide area networks. In some implementations, a STA may also be used as an AP.

An AP may also include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A STA may also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Certain wireless devices, whether used as a STA, AP, or another wireless communication device, may implement the 802.11ah standard and may be used for smart metering or in a smart grid network. Such devices may provide sensor applications or be used in home automation. The devices may instead, or in addition to, be used in a healthcare context, for example for personal healthcare. They may also be used for surveillance, to enable extended-range Internet connectivity (e.g., for use with hotspots), or to implement machine-to-machine communications.

In some domains or locations, transmission power of a device in a wireless communication system may be limited by regulation or a standard, for example, to prevent interference with other devices and/or for safety of people and/or animals. Power transmission limits may apply to any type of wireless communication device, or certain limits may apply to certain categories of devices. For example, for a Wi-Fi system located in a residential or commercial setting, a certain power transmission limit may regulate the transmission of user equipment, wireless routers, and modems. In other areas, certain limits on the amount of power that may be transmitted may apply to APs and STAs. In some circumstances, a limit on the amount of power that may be transmitted in an area may be defined as an average transmission power that is transmitted by any device over a certain amount of time. In other words, such regulations may limit the amount of power contained in transmissions of any one or multiple devices within an area during a certain period (or duration) of time. While a peak transmission power may be higher (or greater) than a defined threshold, an average power transmission over a certain time period (for example, a predetermined time period) may be controlled to be below a regulatory limit.

Implementations described herein relate to methods, apparatus and systems for transmitting data such that the average transmit power over a certain time period, or cycle time, is below a (regulatory) limit. This can also be characterized as controlling or determining a duty cycle transmission such that an average transmission of power over a duty cycle is below a regulatory limit. A certain duty cycle may refer to the time that a device is transmitting as a fraction of the total time being considered, for example, that the device is active, or a period of time that includes a transmission portion and a non-transmission portion. In some implementations, this may include controlling or coordinating multiple transmitting devices such that the devices avoid transmitting during a specified idle time of other devices. In some implementations, for a wireless device that will be transmitting data for a certain amount of time, an idle time period or segment can be determined during which transmissions do not occur. The idle time segment can be determined such that the transmission power of a wireless device, when averaged over the transmission time and the idle time segment, is less than a threshold, for example a regulatory threshold.

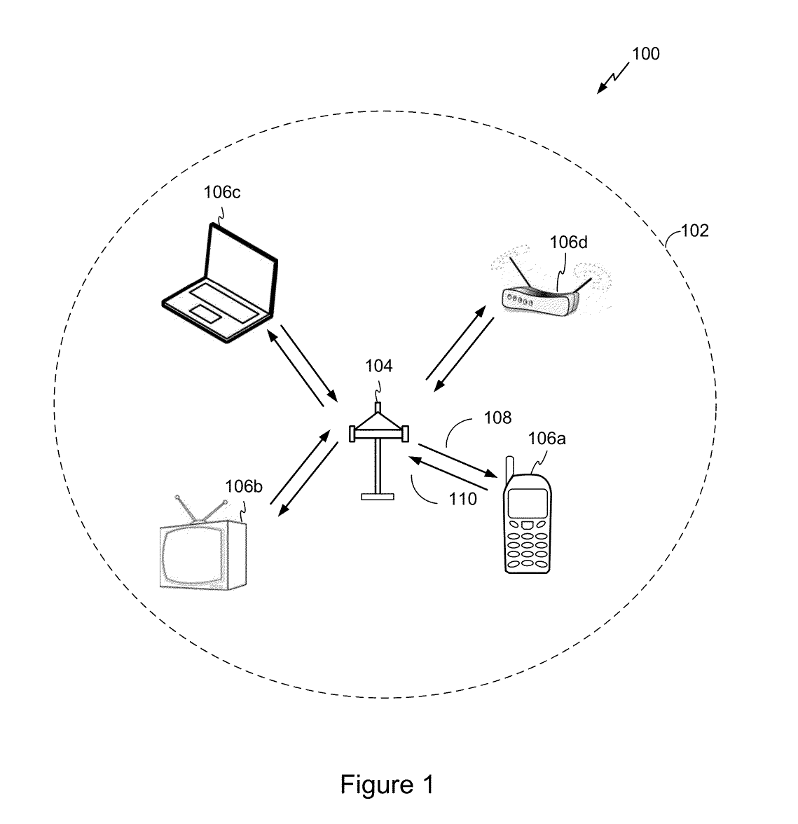

FIG. 1 shows an example of a wireless communication system 100 in which aspects of the present disclosure may be employed. The wireless communication system 100 may operate pursuant to a wireless standard, for example, a 802.11ah standard. The illustrated wireless communication system 100 includes an access point 104, which communicates with one or more stations 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the access point 104 and the STAs 106 in accordance with CDMA techniques. If this is the case, the wireless communication system 100 may be referred to as a CDMA system.

A communication link that facilitates transmission from the access point 104 to one or more of the STAs 106 may be referred to as a downlink (DL) 108, and a communication link that facilitates transmission from one or more of the STAs 106 to the access point 104 may be referred to as an uplink (UL) 110. Alternatively, a downlink 108 may be referred to as a forward link or a forward channel, and an uplink 110 may be referred to as a reverse link or a reverse channel.

The access point 104 may act as a base station and provide wireless communication coverage in a basic service area (BSA) 102. The AP 104 along with the stations 106 associated with the AP 104 and that use the AP 104 for communication may be referred to as a basic service set (BSS). It should be noted that in some implementations the wireless communication system 100 may not have a central access point 104, but rather may function as a peer-to-peer network between the STAs 106. Accordingly, the functions of the access point 104 described herein may alternatively be performed by one or more of the STAs 106.

The access point 104 may transmit a beacon signal (also referred to simply as a “beacon”), via a communication link (for example, the downlink 108) to the stations 106 of the system 100, which may help the STAs 106 synchronize their timing with the AP 104. A beacon may also provide other information or functionality. Beacons may be transmitted periodically. Transmission of a beacon may be divided into a number of groups or intervals. In one aspect, a beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g., shared) for several devices, and information specific to a given device.

In some aspects, a STA 106 may be required to associate with the access point 104 in order to send communications to and/or receive communications from the access point 104. In one aspect, information for associating is included in a beacon broadcast by the access point 104. To receive such a beacon, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the access point 104. In some aspects, the access point 104 may use backhaul services, for example, to communicate with a larger network, such as the Internet or a public switched telephone network (PSTN).

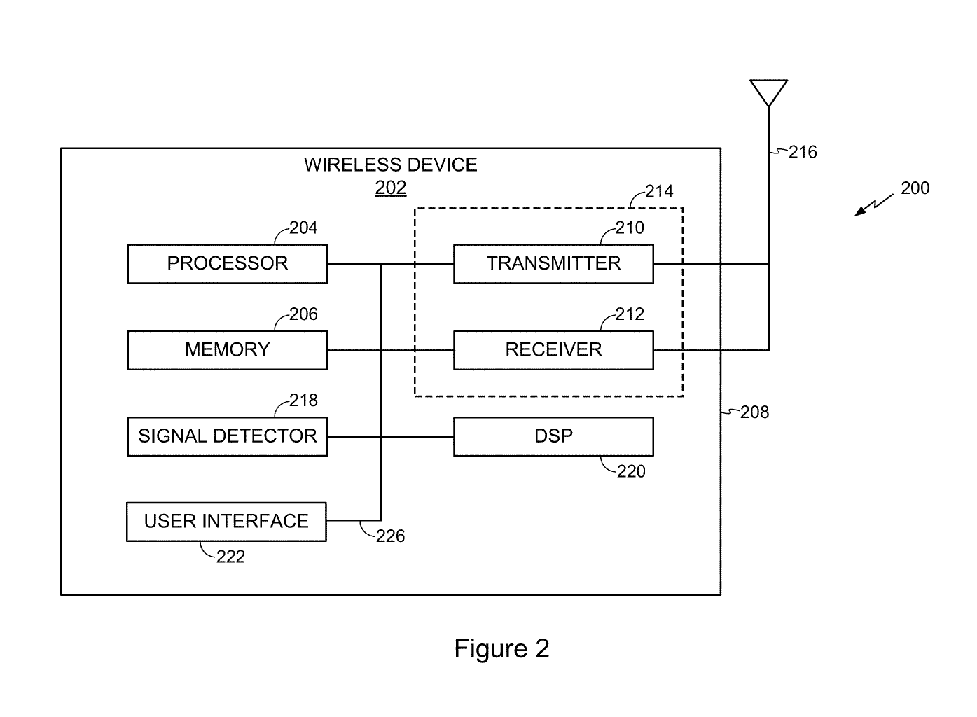

FIG. 2 shows an exemplary functional block diagram of a wireless device 202 that may be employed within the wireless communication system 100 of FIG. 1. The wireless device 202 is an example of a device that may be configured to implement the various methods described herein. In some implementations, the wireless device 202 may be the access point 104 or one of the stations 106.

The wireless device 202 may include a processor 204 which controls operation of the wireless device 202. The processor 204 may also be referred to as a central processing unit (CPU). Memory 206, which may include both read-only memory (ROM) and random access memory (RAM), is coupled to the processor 304 and in communication with the processor 204, and may provide instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to perform one or more of the methods and processes described herein.

The processor 204 may include, or be a component of, a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information.

The processing system may also include machine-readable media for storing software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the one or more processors, may cause the processing system to perform one or more of the functions described herein.

The wireless device 202 may also include a housing 208, and a transmitter 210 and/or a receiver 212 to allow transmission and reception of data between the wireless device 202 and a remote location. In some implementations, the transmitter 210 and receiver 212 may be combined into a transceiver 214. An antenna 216 may be attached to the housing 208 and electrically coupled to the transceiver 214. In some implementations, the wireless device 202 may also include (not shown) multiple transmitters, multiple receivers, multiple transceivers, and/or multiple antennas.

The transmitter 210 may be configured to wirelessly transmit messages (which may be referred to as “paging messages”) that are configured to indicate to wireless devices whether or not the wireless devices need to wake up from a doze state and enter an awake state. For example, the transmitter 210 may be configured to transmit paging messages generated by the processor 204, discussed above. When the wireless device 202 is implemented or used as a STA 106, the processor 204 may be configured to process paging messages. In some implementations, the wireless device 202 may be implemented or used as an access point 104. Accordingly, the processor 204 may also be configured to generate paging messages. Also, the receiver 212 may be configured to wirelessly receive paging messages.

The wireless device 202 may also include a signal detector 218 that may be used to detect and quantify the level of signals received by the transceiver 214. The signal detector 218 may detect such signals as total energy, energy per subcarrier per symbol, and/or power spectral density and in other ways. The wireless device 202 may also include a digital signal processor (DSP) 220 for processing signals. The DSP 220 may be configured to generate a packet for transmission. In some aspects, the packet may include a physical layer data unit (PPDU).

In some implementations, wireless device 202 may also include a user interface 222. The user interface 222 may include a keypad, a microphone, a speaker, and/or a display. The user interface 222 may include any element or component that conveys information to a user of the wireless device 202 and/or receives input from a user.

The various components of the wireless device 202 may be coupled together by a bus system 226. The bus system 226 may include a data bus, and may also include a power bus, a control signal bus, and/or a status signal bus in addition to the data bus. The wireless device 202 may also include other components or elements not illustrated in FIG. 2. One or more of the components of the wireless device 202 may be in communication with another one or more components of the wireless device 202 by means of another communication channel not shown, to provide, for example, an input signal to the other component.

Although a number of separate components are illustrated in FIG. 2, one or more of the components may be combined or commonly implemented. For example, the processor 204 and the memory 206 may be embodied on a single chip. The processor 204 may additionally, or in the alternative, contain memory, such as processor registers. Similarly, one or more of the functional blocks or portions of the functionality of various blocks may be embodied on a single chip. Alternatively, the functionality of a particular block may be implemented on two or more chips. For example, the processor 204 may be used to implement not only the functionality described above with respect to the processor 204, but also to implement the functionality described above with respect to the signal detector 218 and/or the DSP 220.

In this disclosure, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as shown and described in FIG. 2. One or more of the functional blocks and/or one or more combinations of the functional blocks described with respect to any user equipment devices or components, or other equipment described or illustrated herein, may be implemented as a combination of computing devices, e.g., a combination of a DSP and a microprocessor, a plurality of microprocessors, one or more microprocessor in conjunction with a DSP communication, or any other such configuration.

The wireless device 202 may operate as an access point 104 or station 106, and may be used to transmit and/or receive communications including paging messages. That is, either the AP 104 or the STA 106 may serve as transmitter or receiver devices of paging messages. Certain implementations contemplate a signal detector 218 being used with software running on memory 206 and processor 204 to detect the presence of a transmitter or receiver.

A STA 106 may have a plurality of operational modes. For example, the STA 106 may have a first operational mode referred to as an active mode. In the active mode, the STA 106 may be in an “awake” state and actively transmit/receive data with the access point 104. Further, the STA 106 may have a second operational mode referred to as a power save mode. In the power save mode, the STA 106 may be in the “awake” state or a “doze” (or “sleep”) state where the STA 106 does not actively transmit/receive data with the access point 104. For example, the receiver 212 and possibly DSP 220 and signal detector 218 of the STA 106 may operate using reduced power consumption in the doze state. Further, in the power save mode, the STA 106 may occasionally enter the awake state to listen to messages from the access point 104 (e.g., paging messages) that indicate to the STA 106 whether or not the STA 106 needs to “wake up” (e.g., enter the awake state) at a certain time so as to be able to transmit/receive data with the access point 104.

Accordingly, in certain wireless communication systems 100, the access point 104 may transmit paging messages to a plurality of STAs 106 in a power save mode in the same network as the access point 104, indicating whether or not there is data buffered at the access point 104 for the STAs 106. The STAs 106 may also use this information to determine whether they need to be in an awake state or a doze state. For example, if an STA 106 determines it is not being paged, it may enter a doze state. Alternatively, if the STA 106 determines it may be paged, the STA 106 may enter an awake state for a certain period of time to receive the page and further determine when to be in an awake state based on the page. Further, the STA 106 may stay in the awake state for a certain period of time after receiving the page. In another example, the STA 106 may be configured to function in other ways when being paged or not being paged that are consistent with this disclosure.

In some aspects, paging messages may include a bitmap (not shown in this figure), such as a traffic identification map (TIM). In certain such aspects, the bitmap may include a number of bits. These paging messages may be sent from the access point 104 to STAs 106 in a beacon or a TIM frame. Each bit in the bitmap may correspond to a particular STA 106 of a plurality of STAs 106, and the value of each bit (e.g., 0 or 1) may indicate the state the corresponding STA 106 should be in (e.g., doze state or awake state). Accordingly, the size of the bitmap may be directly proportional to the number of STAs 106 in the wireless communications system 100. Therefore, a large number of STAs 106 in the wireless communications system 100 may result in a large bitmap.

Transmission power of a device in a wireless communication system may be limited by regulation or a standard, for example, to prevent interference with other devices and/or for safety. Power transmission limits may apply to any type of wireless communication device, or certain limits may apply to certain categories of devices, including, for example, Wi-Fi systems, user equipment, wireless routers and modems, access points and stations. Certain implementations described herein relate to methods, apparatus and systems for transmitting data such that an average transmission of power (sometimes referred to as “average transmit power”) over a certain period of time (for example, a cycle time) is below a regulatory limit. In other words, certain implementations may control, or determine, duty cycle transmissions such that the average transmit power over the duty cycle time is below a regulatory limit, for example, a predetermined threshold limit set by a regulatory body. This may include controlling or coordinating multiple transmitting devices such that the devices avoid transmitting during a specified idle time of other devices. In some implementations, to determine the average transmit power, a device may use transmission information that is stored in memory, the transmission information identifying data for a particular device which may include indicating transmission power of the device. This transmission information may include data to account for temperature (for example, temperature of the device), battery life, or other device specific conditions (for example, electrical and transmission characteristics of the transmitter in a device). Determining the average transmit power may include determining and controlling the duration (time) and/or power of a transmission. In some implementations, a transmission power may be determined based on monitoring and/or measuring one or more characteristics of the device during an actual transmission. In some implementations, the device may determine average transmission power based at least in part on data stored in the memory of the device.

In some implementations, controlling the average transmitted power by one or more devices may be achieved by signaling a packet duration for the purpose of clear channel assessment (CCA) that includes both the transmit time and the idle time for the one or more devices. In some implementations, the transmit time may be signaled separately, either through a second length field or through an end of frame delimiter that delimits the end of the transmission. The second length field may indicate what portion of the total packet contains the actual transmission. This could be in terms of microseconds, or symbols or bytes. In some implementations, no transmission is made to indicate the end of an idle time segment. In some implementations, a packet duration for purpose of CCA may be signaled in an omnidirectional portion of the PHY header of the packet. The actual transmit time may be signaled in the PHY header or as part of the MAC portion (either as a length field or through an end of frame delimiter).

The actual transmission may occur at the start of the packet, followed by the idle time, but it may also start after some initial idle time, or even be fragmented and separated by multiple instances of idle time. The specific transmit schedule may be agreed upon through prior negotiation, or by convention in the standard, or it may be signaled as part of the PHY header so that it can be modified on a packet by packet basis. The transmission is referred to as the PHY service data unit (PSDU). The PSDU may be fragmented inside a single packet.

In another implementation, the packet duration for each packet is fixed, but the transmit time is limited by either the duty cycle or the amount of data to be transmitted. In this case, the PHY header may signal the duration of the transmission (the PSDU), or the MAC may signal this through a length field or an end of frame delimiter or both.

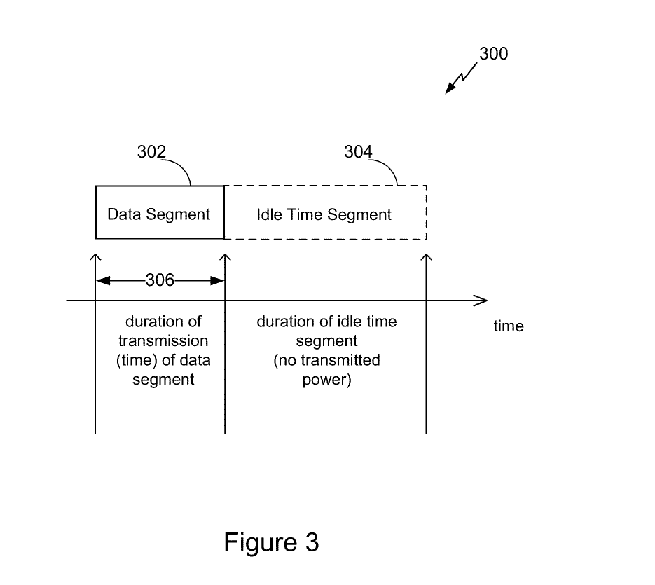

FIG. 3 illustrates a schematic of a data segment 302 and an idle time segment 304 that may form a part of a packet 300. The data segment 302 includes data (or information) that is to be transmitted. Transmitting the data segment 302 may take a certain length of time and a certain amount of power, as represented a the duration of transmission of data segment 306, which may be affected by the amount of data, and network/equipment transmission characteristics. In some implementations, an average amount of transmission power for a device may be determined by a power output for transmitting the data segment 302 divided by a total length of time of the data segment and the idle time segment.

Idle time segment 304 is a length or a duration of time in which no transmissions are made within an area or a domain by the device that is transmitting the data segment 302. In other words, the transmitter of the device is idle with regards to transmitting signals such that the transmitter does not have a transmission power output. In some implementations, the transmissions of devices in a certain area are controlled (or coordinated) such that during the idle time segment of one device no other wireless devices within the certain area transmits. In some implementations, a processor of a wireless device transmitting the data segment 302 determines or calculates the idle duration at least partially based on power transmission information that the wireless device has stored in memory, or information that the wireless device receives. In some implementations, the duration of the idle time segment 304 may be determined such that the average transmission power during a time period that includes the duration for transmitting the data segment 302 and the duration of the idle time segment 304 is below a threshold, such as a regulatory threshold.

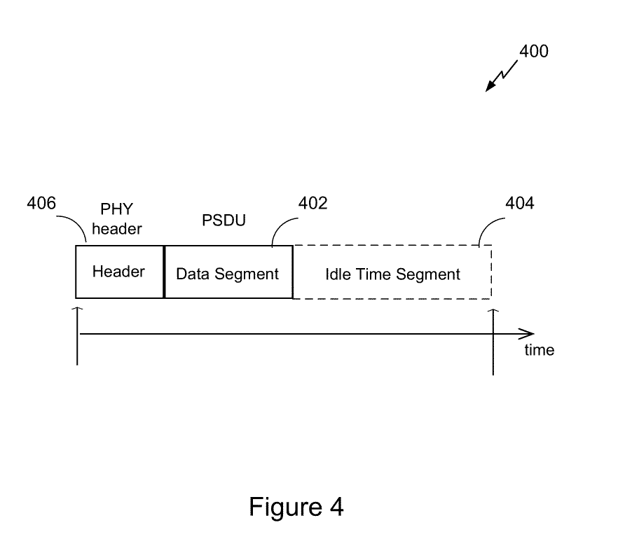

FIG. 4 illustrates a packet 400 that includes a header 406, a data segment 402 and an idle time segment 404. The header 406 may be a physical layer (PHY) header. In one implementation, the header 406 may be an IEEE 802.11 PHY header. The data segment 402 may be a PHY service data unit. In some transmissions, a portion of time over which average power may be calculated for transmitting packet 400 includes time for transmitting the header 406 and the data segment 402, and the idle time segment 404, a portion of time during when no transmission occurs. In some transmissions, the portion of time over which average power may be calculated for transmitting packet 400 includes time for transmitting the data segment 402 and the idle time segment 404 (a portion of time during when no transmission occurs). In some other transmissions, the portion of time over which average power may be calculated for transmitting packet 400 further includes time for transmitting the header 406.

In some implementations, a packet duration may be signaled via the header 406. A portion of time over which an average power is calculated for transmitting packet 400 may be referred to as the “packet duration.” The header 406 may include information that indicates the packet duration, for example, indicating the transmission time portion and/or the idle time portion.

In some implementations, the actual transmission time may be part of a MAC portion either as a length field or through an end of frame delimiter. For example, information related to the actual transmission time of at least one of the header 406, the data segment 403 or the idle time segment 404 may be indicated by at least one of a MAC Service Data Unit (MSDU) or a MAC Protocol Data Unit (MPDU) that is a part of a MAC layer communication between a transmitter and a receiver. In another implementation, there is an additional end of frame delimiter that is not shown in FIG. 4 for indicating a transmission duration of the packet 400. This end of frame delimiter may be sent at the end of the data segment 403 and/or after the idle time segment 404 of the packet 400. In such cases, a receiver may calculate a transmission duration of the packet 400 from detecting the end of frame delimiter.

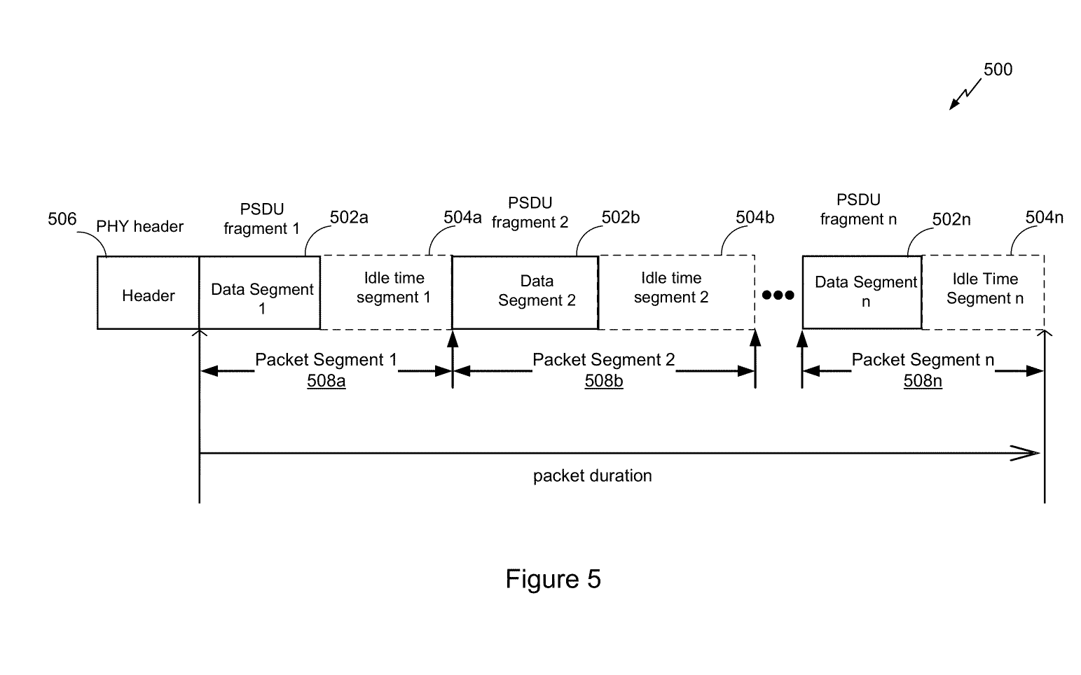

FIG. 5 illustrates a packet 500 for an example of an implementation where a transmission of data is fragmented and duty cycled. The packet 500 includes a header 506 and a plurality of packet segments 508a-508n. The packet duration may be signaled in the header 506, including information indicating the packet transmit times and the idle time. Each of the packet segments 508a-508n may include one or more data segments and one or more idle segment. In each packet segment, the one or more data segments are consecutive to (or next to either before or after) the one or more idle segments.

In some implementations, there is no interlacing between the data segments and the idle segments in the same packet segment. For example, the packet segment 508a includes a first data segment 502a (for example, PSDU fragment 1 shown in FIG. 5) following the header 506, and a first idle time segment 504a following the first data segment 502a. The packet segment 508b includes a second data segment 502b (for example, PSDU fragment 2) following the first idle time segment 504a, and a second idle time segment 504b following the second data segment 502b. The packet segment 508n includes a data segment 502n and an idle time segment 504n. In some implementations, the packet 500 may contain additional packet segments as well as the data segments and idle time segments. The idle time segments 504a-504n may be determined such that the average transmission power for transmitting packet 500 having fragmented data is less than a power threshold.

In some implementations, a packet duration for each packet is fixed (or of a certain standard duration), but the transmit time may be limited by either the duty cycle or the amount of data to be transmitted. In these cases, information in the header may signal the duration of the transmission (the PSDU), or the MAC may signal the duration of the transmission through a length field or an end of frame delimiter, or both. In other words, in this implementation the total packet duration (including the idle portion) may be fixed and therefore not included in the PHY or MAC header (because it is known by all other devices in the network).

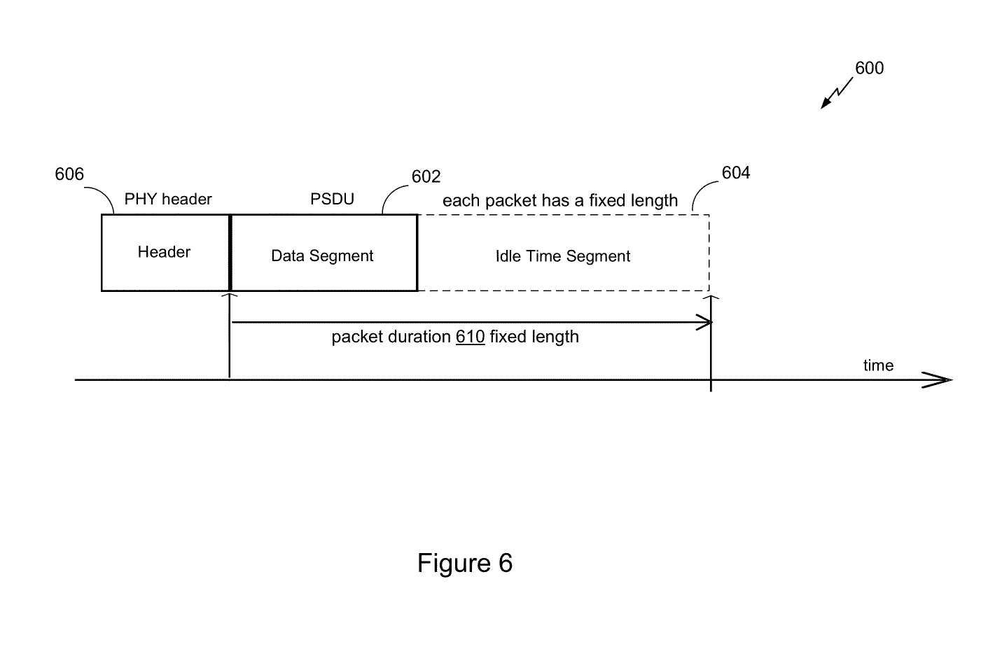

FIG. 6 illustrates a packet 600 having a fixed packet duration 610 and including a data segment 602, an idle time segment 604 and a header 606. In some implementations, a header 606 of the packet 600 has information indicating the duration 610 of a transmission period of the packet 600. For example, the header 606 may contain information indicating a length of time for transmitting the data segment 602. The header 606 may contain information indicating a length of time of the idle time segment 604. In other words, the duration of a time period indicates when there is no transmission after transmitting the data segment 602. In some implementations, the information of the packet duration 610 is signaled via a multiple access control (MAC) layer. For example, information related to the packet duration 610 of each transmission period may be included in at least one of a MAC Service Data Unit (MSDU) or a MAC Protocol Data Unit (MPDU). As such, a receiver of the packet 600 may previously obtain the information of the packet duration 610.

In some implementations, information of the packet duration 610 is negotiated and signaled via a connection setup and/or an association setup. For example, when a STA (e.g., any STA 106 of FIG. 1) communicates to associate with or connect to another STA (e.g., another STA 106 of FIG. 1) or an access point (e.g., the access point 04 of FIG. 1), both devices may be configured to negotiate with each other and determine parameters for the packet duration 610 of the packet 600 for at least one next duty cycled transmission.

Information related to the packet duration 610 may include information related to transmission duration of the packet 600, and may include a transmission duration of the header 606. In one implementation, this information may also include information related to a transmission duration of a PSDU included in the data segment 602.

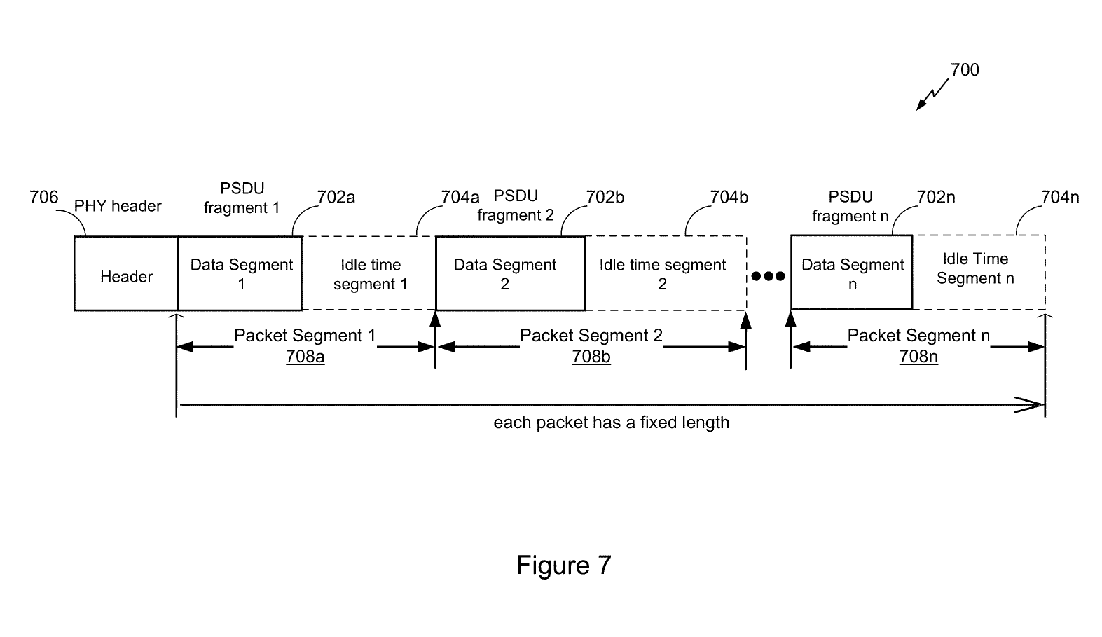

FIG. 7 illustrates an example of a packet 700 having a fixed length. In both FIGS. 6 and 7, a transmission duration of each data segment and/or a total transmission duration for all data segments may be signaled in the header 606 and a header 706 (FIGS. 6 and 7, respectively), or through a MAC layer communication. The packet 700 of FIG. 7 includes multiple packet segments 708a-708n. Each of the packet segments includes at least one data segment and an optional idle time segment. In some implementations, the length of the idle time segments 702a-702n may be the same. In other implementations, lengths of the idle time segments 702a-702n may be the same or be different depending on the length of transmission time for the data segment preceding the idle time segment. In the implementation illustrated in FIG. 7, each idle time segment follows (or is subsequent to in time) the data segment. In another implementation, each idle time segment may be followed by the data segment. For example, in FIG. 7, the packet segment 708a includes a data segment 702a and an idle time segment 704a. The idle time segment follows the data segment 702a. The packet segment 708b includes a data segment 702b and an idle time segment 704b. The idle time segment 704b follows the data segment 702b. The packet segment 708n includes a data segment 702n. Depending on the transmission duration of the packet 700, to meet a power transmission threshold that is based on an amount of power transmitted over a certain time period, the packet segment 708n may include an idle segment 704n. If the transmission duration of the packet 700 is only up to the data segment 702n, then the packet segment 708n may only include the data segment 702n but may not include the idle segment 704n. In some implementations, a transmission schedule for transmitting the data segments may be signaled in the PHY header or it may be signaled through the MAC. In some implementations, the transmission schedule for transmitting the data segments may be determined using a communication standard.

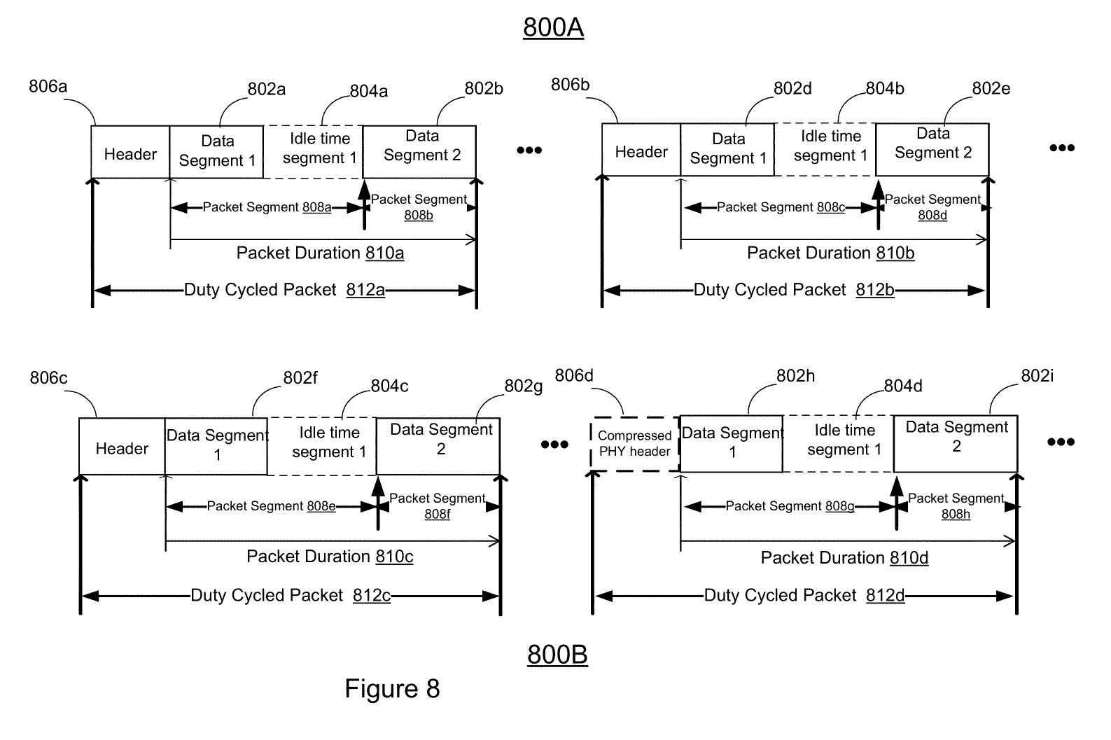

FIG. 8 illustrates two duty cycled transmissions 800A and 800B of multiple packets in one transmission. Each packet in the duty cycled transmissions 800A and 800B is a duty cycled packet and each duty cycled packet includes at least one idle time segment. For example, the duty cycled transmission 800A includes at least two duty cycled packets 812a and 812b and the duty cycled transmission 800B includes at least two duty cycled packets 812c and 812d. As illustrated in FIG. 8, each duty cycled packet includes a header and a packet portion. Each packet portion includes at least one packet segment and each pack segment includes at least one data segment and one optional idle time segment. When a transmitter is transmitting a duty cycled packet, it doesn't transmit any signal during an idle time segment. For example, the duty cycled packet 812a may include a header 806a and a packet portion of a packet duration 810a. In one implementation, the packet portion of the packet duration 810a includes two packet segments 808a and 808b. The packet segment 808a may include a data segment 802a and an idle time segment 804a. The packet segment 808b may include only a data segment 802b. Similar to the duty cycled packet 812a, the duty cycled packet 812b may include a header 806b, a packet segment 808c including a data segment 802d and an idle time segment 804b, and a packet segment 808d. Also similar to the duty cycled packet 812a, the duty cycled packet 812c may include a header 806c, a packet segment 808e (including a data segment 802f) and an idle time segment 804c, and a packet segment 808f. However, in some circumstances (or implementations) headers of some duty cycled packets of the duty cycled transmission 800B may not be transmitted. For example, the header 806d may not be transmitted in the duty cycled packet 812d of the duty cycled transmission 800B.

In one implementation of the duty cycled transmissions 800A and 800B, a transmitter has previously negotiated with a receiver on a transmission timing of multiple duty cycled packets. The transmission timing of the multiple duty cycled packets may be persistent and sequential for a predefined duration. For example, the multiple duty cycled packets 812a, 812b, 812c, 8012d and so on may be transmitted for a voice communication, where the multiple duty cycled packets each are transmitted at a pace of 10 ms or 20 ms. As such, there may be no additional field or signaling in headers of these duty cycled packets for indicating a transmission (transmit) duration and/or an idle time duration of each duty cycled packet. For example, the packet transmission durations 810a, 810b, 810c and 810d may be the same. In some other implementations, positions and transmission durations of the idle time segments 804a, 804 b, 804c and 804d may be the same.

In another implementation of the duty cycled transmission 800B, headers of duty cycled packets may be compressed and some of the header may not be transmitted. For example, in the duty cycled transmission 800B, the header 806d may not be transmitted inside a transmission of the duty cycled packet 812d. One reason for this is that in some implementations, the header 806d is highly correlated with the header 806c. Accordingly, it may not be necessary for the header 806c to be transmitted when the header 806c was transmitted. In some implementations, information of the header 806d was already transmitted before or transmitted through a MAC layer signaling, so it may not be necessary to be transmitted again in the duty cycled transmission 800B.

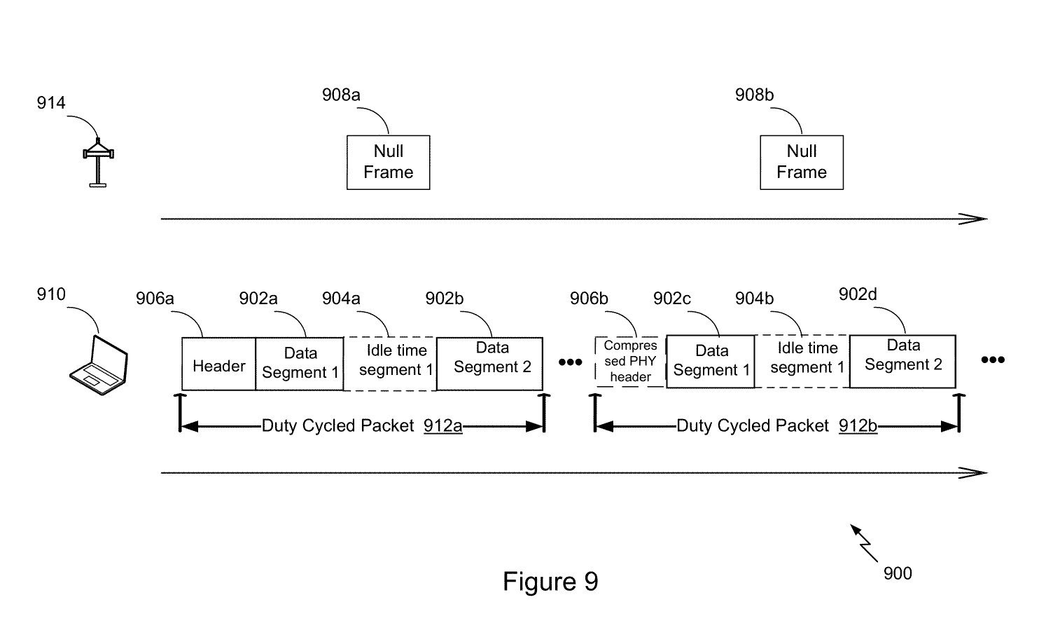

FIG. 9 illustrates a duty cycled transmission 900 from stations 910 and 914. The stations 910 and 914 may be any station 106 and/or the access point 104 of FIG. 1. The duty cycled transmission 900 from the station 910 may include at least two duty cycled packets 912a and 912b. The duty cycled packet 912a may include a header 906a, two data segments 902a and 902b, and an idle time segment 904a. The duty cycled packet 912b may include a header 906b, an idle time segment 904b, and two data segments 902c and 902d. The two packets 908a and 908b are transmitted from the station 914. In one implementation, the two packet 908a and 908b are null frames. Each of the two packets 908a and 908b is transmitted during an idle time segment of the station 910, such as the idle time segments 904a and 904b.

In one implementation, because transmission power of the duty cycled transmission 900 is relatively low, other stations (e.g., any station 106 of FIG. 1, not shown in FIG. 9) may have difficulties in detecting the transmission power of the duty cycled transmission 900. As such, when some stations are doing a clear channel assessment, these stations may not be able to detect that the station 910 is transmitting the duty cycled packets 912a and 912b. Accordingly, these stations may think there are no other stations nearby using wireless channels and try to send some packets on the wireless channels. As a result, there may be a transmission collision between the station 910 and other neighbor stations.

In another implementation to solve the transmission collision, the station 914 knows a transmission timing of idle time segments sent from the station 910. In some implementations, the station 914 and 912 may have some previous negotiations for deciding a transmission timing of the idle time segments 904a and 904b. In some other implementations, there is another station coordinating transmissions from the stations 910 and 912. As a result, the station 914 may transmit some short packets, such as the null frame 908a and 908b, during a period of each idle time segment, such as the idle time segments 904a and 904b. Accordingly, other stations (not shown in FIG. 9) may be able to detect activities of the stations 910 and 914 and think the wireless channels are busy. Therefore, those other stations may not send packets to interfere with the duty cycled transmission 900. In determining the average power, in some implementations, the short null packets may not have a significant impact to the total transmitted power during a time period and can be ignored. If such null packets do have a significant affect, they can also be taken into account when determining the average power to ensure it meets a regulatory requirement.

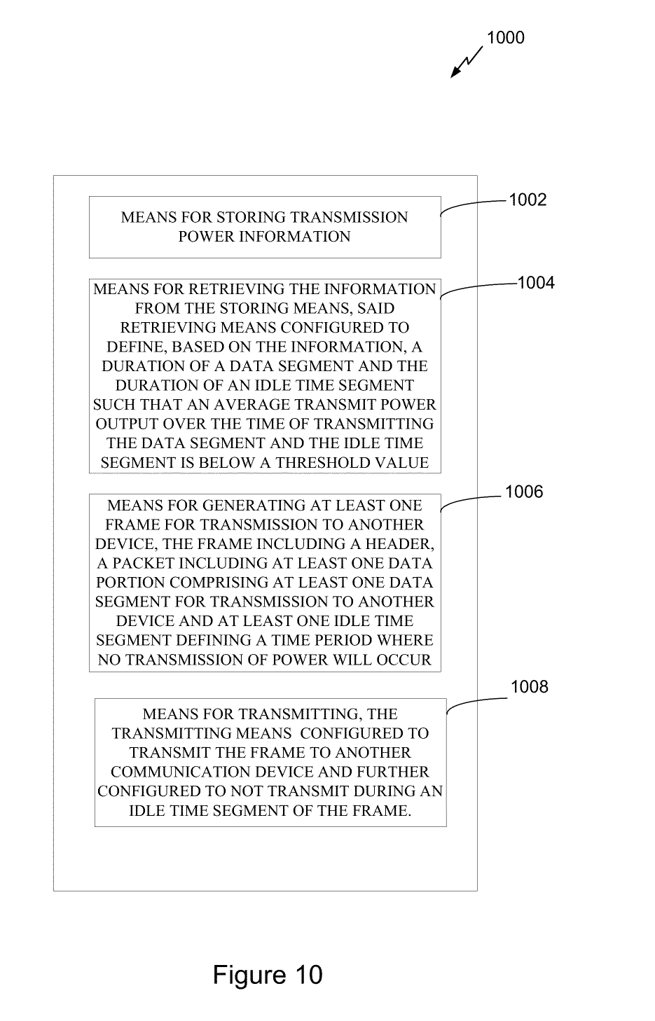

FIG. 10 illustrates a block diagram of a device 1000 that can included components/functionality for defining the duration of at least one data segment and at least one idle time segment that are illustrated in FIG. 3A-3E. In block 1002, the device includes means for storing transmission power information. The storing means may be a memory unit in a wireless device or on a chip. At block 1004, the device includes means for retrieving the information from the memory unit, the retrieving means configured to define, based on the information, a duration of a data segment and the duration of an idle time segment such that an average transmit power output over the time of transmitting the data segment and the idle time segment is below a threshold value. The retrieving means may be a processor, for example, processor 204 illustrated in FIG. 2.

As illustrated in block 1006, the device 1000 also includes means for generating at least one frame for transmission to another device, the frame including a header, a packet including at least one data portion comprising at least one data segment for transmission to another device and at least one idle time segment defining a time period where no transmission of power may occur. The generating means also be a processor, for example, processor 204 illustrated in FIG. 2. The device 1000 may further include means for transmitting, the transmitting means configured to transmit the frame to another communication device and further configured to not transmit during an idle time segment of the frame. The transmitting means can be a transmitter, for example, transmitter 210 as illustrated in FIG. 2.

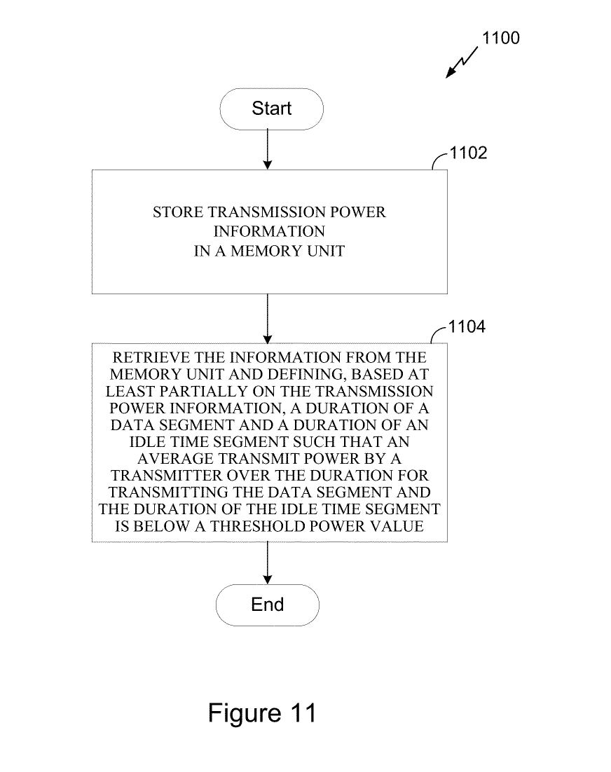

FIG. 11 is a flowchart illustrating a process 1100 for wirelessly communicating such that the average transmission power is less than a threshold. At block 1102 the process 1100 includes storing transmission power information in a memory unit. In some implementations, transmission power information may be stored in a memory unit or the processor of a wireless communication device while the device is operational. For example, the information may be provided to the device using its operational communication means (e.g., a receiver, processor, signal detector, etc.) to receive the data. In some implementations, the information may be provided to the device before the device is operational. For example, the information may be stored in memory of the processor or memory unit at some point when the device is being programmed or configured. A processor of a wireless device may perform this portion of the process 1100. At block 1104, the process 1100 further includes retrieving the information from the memory unit and defining, based at least partially on the transmission power information, a duration of a data segment and a duration of an idle time segment such that an average transmit power by a transmitter over the duration for transmitting the data segment and the duration of the idle time segment is below a threshold power value. A processor of a wireless device may perform this portion of the process 1100.

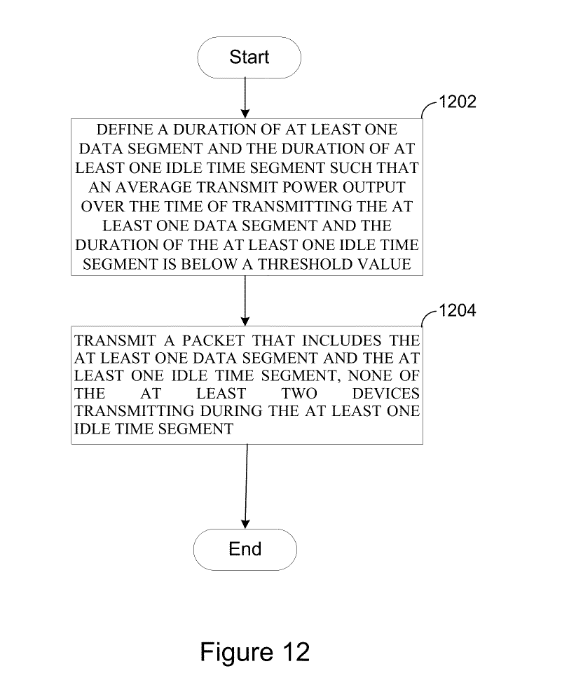

FIG. 12 is a flowchart illustrating a process 1200 for wirelessly communicating such that the average transmission power is less than a threshold. At block 1202 the process 1200 includes defining a duration of at least one data segment and a duration of at least one idle time segment such that an average transmit power output over the time of transmitting the at least one data segment and the duration of the at least one idle time segment is below a threshold value. A processor of a wireless device may perform this portion of the process 1200. At block 1204, the process 1200 includes transmitting in a communication system that includes at least two communication devices, a packet that includes at least one data segment and at least one idle time segment. During the idle time segment none of the at least two communication devices transmits, that is, the at least two communication devices are idle. A transmitter, for example the transmitter 210, or a transceiver, for example transceiver 214 (FIG. 2) may perform this portion of process 1200.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may include non-transitory computer readable medium (e.g., tangible media). In addition, in some aspects computer readable medium may include transitory computer readable medium (e.g., a signal). Combinations of the above should also be included within the scope of computer-readable media.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may include a computer program product for performing the operations presented herein. For example, such a computer program product may include a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for wireless communication, the apparatus comprising:
a memory unit configured to store transmission power information; and
a processor operationally coupled to the memory unit, the processor configured to retrieve the transmission power information from the memory unit and further configured to define, based at least partially on the transmission power information, a duration of a data segment and a duration of an idle time segment such that an average transmit power by a transmitter over the duration of the data segment and the duration of the idle time segment is below a threshold power value.

2. The apparatus of claim 1, further comprising a transmitter configured to transmit the data segment to another communication device, wherein the apparatus is configured to not transmit during the idle time segment.

3. The apparatus of claim 2, wherein the processor is further configured to define, based at least partially on the transmission power information, the duration of a data segment and at least one idle time segment such that an average transmit power by a transmitter over the duration of the data segment and the duration of the at least one idle time segment is below the threshold power value.

4. The apparatus of claim 1, wherein the processor is further configured to define, based at least partially on the transmission power information, a duration of a plurality of data segments and a plurality of idle time segments such that an average transmit power by a transmitter over the duration of the plurality of data segments and the duration of the plurality of idle time segment is below the threshold power value.

5. The apparatus of claim 4, further comprising a transmitter configured to transmit the plurality of the data segments to another communication device, the transmitter further configured to not transmit during the plurality of the idle time segments, and wherein the plurality of the data segments and the plurality of the idle time segments are ordered such that each of the plurality of the idle time segments follows a transmission of each of the plurality of the data segments.

6. The apparatus of claim 1, wherein the processor defines a plurality of packets to transmit, each packet including a data portion and an idle time portion, such that an average transmit power, determined over a time period, to transmit the plurality of packets and not transmit during the duration of the plurality of idle time segments is below the threshold power value.

7. The apparatus of claim 1, wherein the transmission power information includes the threshold power value.

8. The apparatus of claim 7, wherein the threshold power value is a pre-defined regulatory limit.

9. The apparatus of claim 1, wherein the transmission power information includes transmitter power data for the apparatus.

10. The apparatus of claim 1, wherein the transmission power information includes a transmission duration and an idle time duration.

11. The apparatus of claim 1, wherein the processor is further configured to store received transmission power information in the memory unit.

12. The apparatus of claim 11, wherein the apparatus further comprises a receiver, and wherein the apparatus is configured to receive the transmission power information via the receiver.

13. The apparatus of claim 1, wherein the processor is further configured to generate at least one packet for transmission to another device, each packet comprising
a header;
a packet segment including
a data portion comprising at least one data segment for transmission to another device, and
at least one idle time segment defining a time period where no transmission of power occurs.

14. The apparatus of claim 13, wherein the data portion comprises two or more data segments and two or more idle time segments, each of the two or more data segments being followed by an idle time segment.

15. The apparatus of claim 13, wherein the data portion comprises a physical layer (PHY) service data unit (PSDU).

16. The apparatus of claim 13, wherein the header comprises a transmit time field indicating the length of time to transmit the at least one data segment.

17. A method of transmitting data, the method comprising:
storing transmission power information in a memory unit; and
retrieving the transmission power information from the memory unit and defining, based at least partially on the transmission power information, a duration of a data segment and a duration of an idle time segment such that an average transmit power by a transmitter over the duration for transmitting the data segment and the duration of the idle time segment is below a threshold power value.

18. The method of claim 17, further comprising transmitting a packet over a time period that includes the time to transmit the at least one data segment and the time of non-transmission of the at least one idle time segment.

19. The method of claim 18, further comprising coordinating transmissions with at least one wireless device having a transmitter such that no transmissions occur during the duration of the at least one idle time segment.

20. The method of claim 19, further comprising defining, based at least partially on the transmission power information, the duration of the data segment and at least one idle time segment such that an average transmit power by a transmitter over the duration of the data segment and the duration of the at least one idle time segment is below the threshold power value

21. The method of claim 18, further comprising defining, based at least partially on the transmission power information, the duration of a plurality of data segments and a plurality of idle time segments such that an average transmit power by a transmitter over the duration of the plurality of data segments and the duration of the plurality of idle time segment is below the threshold power value.

22. The method of claim 21, further comprising transmitting the data segments to another communication device, the transmitter further configured to not transmit during the idle time segments, and wherein the plurality of the data segments and the plurality of the idle time segments are ordered such that each of the plurality of the idle time segments follows a transmission of each of the plurality of the data segments.

23. The method of claim 17, further comprising defining a plurality of packets to transmit, each packet including a data portion and an idle time portion, such that an average transmit power, determined over a time period, to transmit the plurality of packets and not transmit during the duration of the plurality of idle time segments is below a threshold power value.

24. The method of claim 17, wherein the transmission power information includes the threshold value.

25. The method of claim 24, wherein the threshold value is a pre-defined regulatory limit.

26. An apparatus for transmitting data, the apparatus comprising:
means for storing transmission power information in a memory unit; and
means for retrieving the transmission power information from the memory unit and defining, based at least partially on the transmission power information, a duration of a data segment and a duration of an idle time segment such that an average transmit power by a transmitter over the duration for transmitting the data segment and the duration of the idle time segment is below a threshold power value.

27. The apparatus of claim 26 further comprising means for transmitting a packet over a time period that includes the time to transmit the at least one data segment and the time of non-transmission of the at least one idle time segment.

28. The apparatus of claim 27, further comprising means for defining, based at least partially on the transmission power information, the duration of a plurality of data segments and a plurality of idle time segments such that an average transmit power by a transmitter over the duration of the plurality of data segments and the duration of the plurality of idle time segment is below the threshold power value.

29. The apparatus of claim 26, further comprising means for defining a plurality of packets to transmit, each packet including a data portion and an idle time portion, such that an average transmit power, determined over a time period, to transmit the plurality of packets and not transmit during the duration of the plurality of idle time segments is below a threshold power value.

30. A non-transitory computer storage medium that stores executable program instructions that direct an apparatus including a processor to perform a process that comprises:
storing transmission power information in a memory unit; and
retrieving the transmission power information from the memory unit and defining, based at least partially on the transmission power information, a duration of a data segment and a duration of an idle time segment such that an average transmit power by a transmitter over the duration for transmitting the data segment and the duration of the idle time segment is below a threshold power value.

31. The storage medium of claim 30, wherein the process further comprises transmitting a packet over a time period that includes the time to transmit the at least one data segment and the time of non-transmission of the at least one idle time segment.

32. The storage medium of claim 30, wherein the process further comprises defining, based at least partially on the transmission power information, the duration of a plurality of data segments and a plurality of idle time segments such that an average transmit power by a transmitter over the duration of the plurality of data segments and the duration of the plurality of idle time segment is below the threshold power value.

33. The storage medium of claim 30, wherein the process further comprises defining a plurality of packets to transmit, each packet including a data portion and an idle time portion, such that an average transmit power, determined over a time period, to transmit the plurality of packets and not transmit during the duration of the plurality of idle time segments is below a threshold power value.

34. A communication system, comprising:
at least two communication devices, each device including
a memory unit configured to store transmission power information,
a processor operationally coupled to the memory unit, the processor configured to retrieve the transmission power information from the memory unit and further configured to define, based on the transmission power information, a duration of a data segment and a duration of an idle time segment such that an average transmit power by a transmitter over the duration of the data segment and the duration of the idle time segment is below a threshold power value, and the processor further configured to generate packets that includes at least one data segment and idle time segment; and
a transceiver configured to communicate the data packets with another of the at least two communication devices;
wherein each of the communication devices is configured not to transmit while during an idle time segment of a packet it is communicating, and not to transmit during an idle time segment of a packet that another of the at least two communication devices is communicating.

35. A method of communicating data between at least two devices, the method comprising:
defining a duration of at least one data segment and the duration of at least one idle time segment such that an average transmit power output over the time of transmitting the at least one data segment and the at least one idle time segment is below a threshold value; and
transmitting a packet that includes the at least one data segment and the at least one idle time segment, none of the at least two devices transmitting during the at least one idle time segment.
